(19) United States
(12) Patent Application Publication
(10) Pub. No.: US 2016/0349117 A1
(43) Pub. Date: Dec. 1, 2016

(54) DEVICE FOR MEASURING A TEMPERATURE DIFFERENTIAL

(71) Applicant: SC2N, Creteil Cedex (FR)

(72) Inventors: Pascal Castro, Ouistreham (FR); Mahmoud Sfaxi, Ouistreham (FR)

(73) Assignee: SC2N, Creteil (FR)

(21) Appl. No.: 15/106,613

(22) PCT Filed: Dec. 19, 2014
(86) PCT No.: PCT/FR2014/053447

§ 371 Date: Aug. 23, 2016

(30) Foreign Application Priority Data
Dec. 20, 2013 (FR) 1363181

(51) Int. Cl. G01K 3/14; G01K 7/02

(52) U.S. Cl. CPC G01K 3/14; G01K 7/02; G01M 15/10

(57) ABSTRACT

The invention relates to a device (1) for measuring a difference in temperature (T2−T1) upstream and downstream from a member travelled by a fluid, in particular the temperature of a gas upstream and downstream of a particle filter or any other gas-treatment element, said device comprising: a first thermocouple (10) for taking an upstream measurement; a second thermo couple (20) for taking a downstream measurement, the first and second thermocouples being electrically connected head-to-foot in series, at least during an operating phase of the device; a chain (13, 50) for processing the voltage output by the assembly formed by the two thermocouples electrically connected in series, such as to generate a signal (51) which is a function of the temperature difference (T2−T1) measured by the thermocouples.

The present invention relates to the measurement devices used, particularly in motor vehicles, for monitoring and controlling the performances of the exhaust gas treatment elements.

In some applications, it is necessary to measure the temperatures upstream and downstream of a filtering element such as a particle filter. The temperatures are, for example, in the ranges of 400° C. to 700° C.

For this purpose, it is common practice to use two separate sensors with a sensing element of the CNT, plate or thermocouple type, and the temperature differential is determined by an on-board computer.

This solution has the disadvantage of generating a measurement error which corresponds to the accumulation of the inaccuracies of each sensor, which can result in a nonoptimized control of the treatment element(s).

The use of paired sensors may give improved results but at the price of a large cost increase and a relatively complex implementation.

The invention aims to propose a measurement device having improved accuracy, which is still simple to use and highly reliable.

Thus, the invention relates to a device for measuring a difference in temperature upstream and downstream of a part through which a fluid flows, in particular the temperature of a gas upstream and downstream of a particle filter or any other gas treatment element, said device comprising:
a first thermocouple for carrying out an upstream measurement,
a second thermocouple for carrying out a downstream measurement, the first and second thermocouples being electrically series-connected head-to-tail, at least during a phase of operation of the device,
a processing chain for processing the voltage delivered by the assembly formed by the two electrically series-connected thermocouples, so as to generate a signal which is a function of the difference in temperature measured by the thermocouples.

By means of the invention, it is possible to read the difference in temperature without accumulation of the measurement inaccuracies of each sensor.

Preferably, the two thermocouples are identical. The series connection of the two thermocouples, each comprising a junction between metals M1/M2, occurs in such a manner that the metals M1 are connected to one another.

The thermocouples used are preferably K type or N type. The thermocouples used can be different from thermocouples of type T.

The two thermocouples can be permanently electrically series-connected. In a variant, the device can comprise a switching system that can assume at least two states:
a first state in which at least one of the two thermocouples is connected to the input of an amplifier so as to enable the processing chain to deliver a signal corresponding to at least one of the temperatures,
a second state in which the two thermocouples are electrically series-connected to the input of an amplifier, so as to enable the processing chain to deliver a signal corresponding to the difference in temperature.

In the first state, the two thermocouples can each be connected respectively to the input of an amplifier, so as to enable the processing chain to deliver signals corresponding respectively to the temperatures of the thermocouples.

In the second state, one of the thermocouples can be connected to the input of another amplifier, and the output signal of this other amplifier is processed so as to deliver a signal corresponding to the temperature of this thermocouple.

The device can comprise a cold temperature voltage source used for the calculation of at least one of the temperatures measured by the thermocouples, this voltage being generated, in particular, electronically, as result of the direct measurement of the cold temperature or being imposed by simulation, at least in the first state.

The invention further relates to a vehicle provided with a measurement device according to the invention.

The invention further relates to a method for measuring a difference in temperature upstream and downstream of a part through which a fluid flows, in particular, the temperatures of an exhaust gas upstream and downstream of a particle filter, two thermocouples measuring the upstream and downstream temperatures, respectively, in which:
from the voltage delivered by a first thermocouple, the voltage delivered by a second thermocouple is subtracted, this subtraction being the result of a head-to-tail series connection of the thermocouples,
the difference in voltage thus generated is processed so as to produce a signal representative of the difference in temperature.

The method can comprise the selection of the state of a switching system that can assume two states:
a first state in which at least one of the thermocouples is connected to the input of an amplifier so as to read the temperature of this thermocouple,
a second state in which the two thermocouples are electrically series-connected head-to-tail to the input of an amplifier, so as to read the difference in temperature of the thermocouples.

The two thermocouples can be connected respectively to two amplifiers in the first state, so as to read the temperature of each of the thermocouples.

The switching into the first state can be performed when the measurement of the temperature at two different points corresponding to the thermocouples is required, and the switching into the second state can be performed when the measurement of the difference in temperature between the two points is required.

The invention will be understood better upon reading the following description of embodiment examples that do not limit said invention, and upon examination of the appended drawing in which:

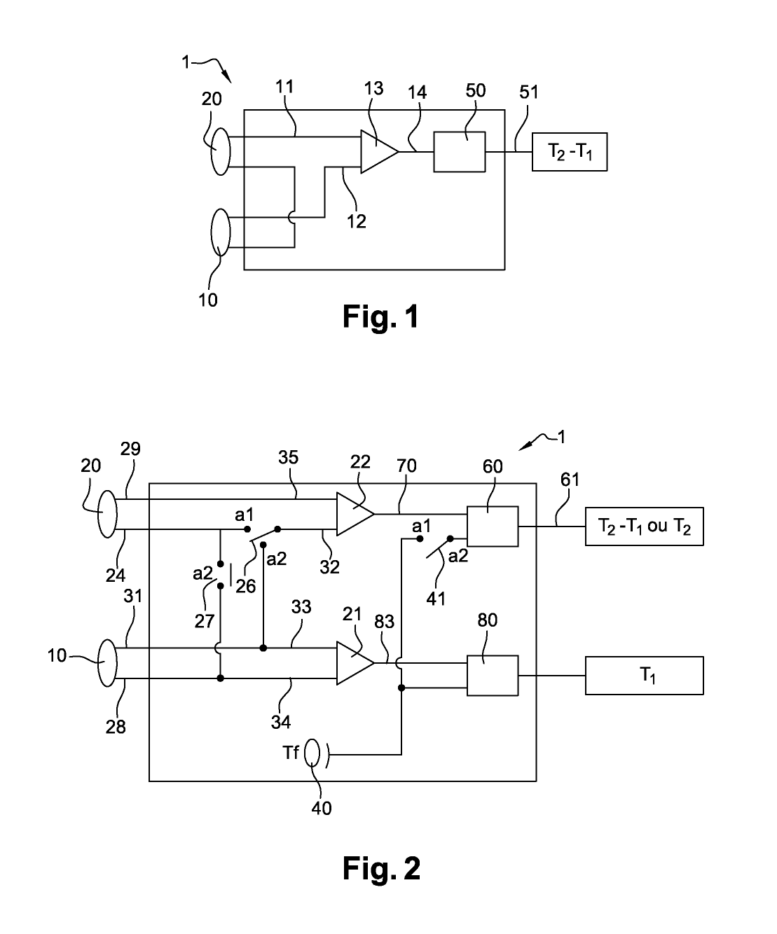

FIG. 1 is an electrical diagram of an example of a measurement device according to the invention, and

FIG. 2 is a view similar to FIG. 1, of an embodiment variant.

In FIG. 1, a measurement device 1 according to the invention is represented, comprising two thermocouples 10 and 20 arranged so as to measure temperatures Ti and T2, upstream and downstream, respectively, of a particle filter through which the combustion gases coming from the exhaust of a heat engine flow.

The thermocouples 10 and 20 are K type or N type, for example, comprising, for example, a junction between two metals consisting respectively of NiCr and Ni, or of NiCrSi and NiSi, for example.

The two thermocouples 10 and 20 are electrically series-connected head-to-tail so that their cold junction temperatures mutually compensate. Thus, the metals Ni or NiSi are, for example, electrically connected to one another in the case of K type or N type thermocouples.

The use of two cross-connected thermocouples results in the fact that one of them is considered the measurement of the cold point of the other thermocouple.

The terminals 11 and 12 of the assembly formed by the two series-connected thermocouples 10 and 20 are, for example, as illustrated, connected to the inputs of a differential amplifier 13 that produces a signal 14 at the output that is sent to processing electronics 50 which applies a processing function suitable for delivering, at the output, a signal 51 corresponding to the difference in temperature T2−T1. The latter can be used in order to control the exhaust gas treatment element(s) appropriately in a conventional way.

In the variant illustrated in FIG. 2, the two thermocouples 10 and 20 are not permanently connected head-to-tail. The thermocouple 10 is permanently connected by its outputs 28 and 31 to the inputs 33 and 34 of a first differential amplifier 21. The thermocouple 20 is connected by an output 29 to an input 35 of a second differential amplifier 22. The other output 24 of the thermocouple 20 is connected through a first switch 26 to the other input 32 of the amplifier 22 and through a second switch 27 to the output 28 of the thermocouple 10. The switch 26 has two states a1 and a2.

In the state a1, the input 32 of the amplifier 21 is connected to the output 24 of the thermocouple 20.

In the state a2, the input 32 of the amplifier 22 is connected to the input 33 of the amplifier 21.

When the switch 26 is in the state a1, the switch 27 is open, and when the switch 26 is in the state a2, the switch 27 is closed.

When the switch 26 is in the state a2, and the switch 27 is closed, the thermocouples 10 and 20 are electrically series-connected head-to-tail, as in the example of FIG. 1, and the outputs of the assembly of the thermocouples 10 and 20 are electrically connected to the inputs 35 and 32 of the amplifier 22. At the output, the latter produces a signal 70 that is sent to processing electronics 60 which applies a function adapted so as to be suitable for delivering a signal 61 which corresponds to the difference in temperature T2−T1.

The other amplifier 21 is connected to the outputs 28 and 31 of the thermocouple 10. When the switch 26 is in the state a1, the switch 27 is open, and the outputs of the thermocouples 10 and 20 are connected to the inputs of the amplifiers 21 and 22, respectively.

In order to read the temperatures T1 and T2, a cold temperature voltage source 40 is built into the processing electronics, so as to read the temperature of the associated thermocouple, in a conventional way.

This source 40 is connected by a switch 41 to the processing electronics 60 downstream of the amplifier 22 only when the switch 26 is in the state a1. It is connected permanently to a processing electronics 80 downstream of the amplifier 21, which processes the signal 83 delivered by the latter.

Thus, when the switch 26 is in the state a2, the source 40 is only connected to the processing electronics 80 downstream of the amplifier 21.

When the switch 26 is in the state a1, the device 1 can read the temperatures T1 and T2, and when the switch 26 is in the state a2, the device 1 reads the temperatures T2−T1 and T1.

The switches 26, 27 and 41 can be implemented in digital or analog form.

The term “amplifier” should not be understood to have a limiting meaning and includes the use as an amplifier of an operational amplifier mounted as a follower, as a filter or with any gain.

The invention is not limited to the examples that have just been described. For example, the invention can be applied to other situations in which a difference in temperature of a fluid must be measured upstream and downstream, respectively, of an element through which this fluid flows.

1. A device for measuring a difference in temperature upstream and downstream of a part through which a fluid flows, comprising the temperature of a gas upstream and downstream of a particle filter said device comprising:
a first thermocouple for carrying out a measurement upstream;
a second thermocouple for carrying out a measurement downstream, the first and second thermocouples being electrically series-connected head-to-tail, at least during a phase of operation of the device; and
a processing chain for processing the voltage delivered by the assembly formed by the two electrically series-connected thermocouples, so as to generate a signal which is a function of the difference in temperature measured by the thermocouples.

2. The device according to claim 1, the two thermocouples being permanently electrically series-connected.

3. The device according to claim 1, comprising a switching system that can assume at least two states:
a first state in which at least one of the two thermocouples is connected to the input of an amplifier, so as to enable the processing chain to deliver a signal corresponding to at least one of the temperatures,
a second state in which the two thermocouples are electrically series-connected to the input of an amplifier, so as to enable the processing chain to deliver a signal corresponding to the difference in temperature.

4. The device according to claim 3, in which, in the first state, the two thermocouples are each connected respectively to the input of an amplifier, so as to enable the processing chain to deliver signals corresponding respectively to the temperatures of the thermocouples.

5. The device according to claim 3, in which, in the second state, one of the thermocouples is connected to the input of another amplifier, and the output signal of said other amplifier is processed so as to deliver a signal corresponding to the temperature of this thermocouple.

6. The device according to claim 3, a cold temperature voltage source used for the calculation of at least one of the temperatures measured by the thermocouples at least in the first state, being, in particular, generated electronically as a result of a direct measurement of the cold temperature or imposed by a simulation.

7. A vehicle provided with a measurement device as defined in claim 1.

8. A method for measuring a difference in temperature upstream and downstream of a part through which a fluid flows, comprising the temperatures of an exhaust gas upstream and downstream of a particle filter, two thermocouples measuring the temperatures upstream and downstream, respectively, in which:
from the voltage delivered by a first thermocouple, the voltage delivered by a second thermocouple is subtracted, this subtraction being the result of a head-to-tail series connection of the thermocouples,
the difference in voltage thus generated is processed so as to produce a signal representative of the difference in temperature.

9. The method according to claim 8, comprising the selection of the state of a switching system that can assume two states:
a first state in which at least one of the thermocouples is connected to the input of an amplifier so as to read the temperature of this thermocouple,
a second state in which the two thermocouples are electrically series-connected head-to-tail to the input of an amplifier, so as to read the difference in temperature of the thermocouples.

10. The method according to claim 9, the two thermocouples being connected respectively to two amplifiers, in the first state, so as to read the temperature of each of the thermocouples.

11. The method according to claim 9, the switching into the first state being carried out when the measurement of the temperatures at two different points corresponding to the thermocouples is required, and the switching into the second state being carried out when the measurement of the difference in temperature between the two points is required.
